(19) United States
(12) Patent Application Publication
(10) Pub. No.: US 2020/0342464 A1
(43) Pub. Date: Oct. 29, 2020

(54) SERVER, METHOD, AND SYSTEM FOR EVALUATING USER BY ANALYZING SOCIAL NETWORK

(71) Applicant: TENSPACE CO., LTD., Seoul (KR)

(72) Inventors: Jin Sug KO, Seoul (KR); Won Hoon CHUNG, Seoul (KR); Sang Yoel NAM, Bucheon-si (KR); Tae Ho KIM, Yeoncheon-gun (KR); Sang Yoon HAN, Seongnam-si (KR); Jin Ho SON, Seoul (KR)

(73) Assignee: TENSPACE CO., LTD., Seoul (KR)

(21) Appl. No.: 16/522,089

(22) Filed: Jul. 25, 2019

Related U.S. Application Data
(63) Continuation of application No. PCT/KR2019/005071, filed on Apr. 26, 2019.

(51) Int. Cl. G06Q 30/02; G06F 16/9535; G06Q 50/00; G06Q 40/02

(52) U.S. Cl. CPC G06Q 30/0201; G06Q 40/025; G06Q 50/01; G06F 16/9535

(57) ABSTRACT

Disclosed is an SNS analysis server. The SNS analysis server includes at least one processor for analyzing SNS activity of a user by using information about an SNS account of the user and information including an evaluation application form of the user, and determining an evaluation score for the user based on the analyzed SNS activity of the user to provide the determined evaluation score. Accordingly, non-target customers who do not have credit assessments may get additional opportunities for loans, and job applicants may get additional employment opportunities based on social assessments. Business operators may hire employees who are more suited to vocational aptitude, block black consumers in advance, and perform marketing by analyzing a marketing target to better understand propensities and needs of customers.

### CROSS-REFERENCE TO RELATED APPLICATIONS

This application is a Continuation of International Application No. PCT/KR2019/005071 filed on Apr. 26, 2019, the entire contents of which are incorporated herein by reference.

### TECHNICAL FIELD

The present invention relates to a server for evaluating a user by analyzing a social network, and a method and a system for evaluating a user by analyzing a social network. More particularly, the present invention is directed to analyze a social network of a user to provide an analyzed result, in order to utilize the analyzed result in various fields such as a credit assessment, a personnel assessment, and marketing.

### BACKGROUND ART

In financial institutions such as banks, when a loan application is submitted from a loan applicant, a loan assessment is conducted based on their own credit score system (CSS) by utilizing CB Score of Credit Bureau (CB). In CB Score, the credit rating has been calculated by inquiring past financial transaction records of the loan applicant such as a card usage record, a payment record of a mobile communication service use fee, and a late payment record of financial transaction.

In this way, since the credit rating of an individual is calculated without reflecting non-financial information in the financial institutions, persons who wish a loan but belong to a blind spot of the credit rating due to lack of financial transactions may be subject to limitation when using financial services. In addition, a person who wishes a loan with a high credit rating due to financial transactions but has a high default rate may not be discriminated.

Further, an enormous expense has been incurred to track additional financial transaction records to calculate the credit rating, and there is no way to actively respond to potential financial risks that may not be predicted.

Moreover, when a company hires a new employee, it is common to go through an interview with a resume. However, it is difficult to clearly identify whether a job applicant is a person appropriate to a company with only the interview and the resume of the job applicant.

In addition, existing marketing analysis programs may not precisely recognize the needs of customers, and may not identify whether the customer is a black consumer in advance.

### DISCLOSURE

### Technical Problem

To solve the problems described above, an object of the present invention is to provide a server for evaluating a user by analyzing a social network of an applicant, a method for evaluating a user by analyzing a social network, and a system configured to recognize a credit assessment of a user, a personnel aptitude assessment, a black consumer, and propensities and needs of customers by using a social network.

### Technical Solution

To achieve the objects described above, according to one embodiment of the present invention, there is provided a server including at least one processor for analyzing SNS activity of a user by using information about an SNS account of the user and information including an evaluation application form of the user, and calculating an evaluation score for the user based on the analyzed SNS activity of the user to provide the calculated evaluation score. Accordingly, non-target customers who do not have credit assessments may get additional opportunities for loans, and job applicants may get additional employment opportunities based on social assessments. Business operators may hire employees who are more suited to vocational aptitude, block black consumers in advance, and perform marketing by analyzing a marketing target to better understand propensities and needs of customers.

The at least one processor may collect at least one of personal information, created contents, shared contents, friend relationship, and activity contents from the SNS account of the user, evaluate a trust index, a communication index, and a management index of the user by performing text mining, opinion mining, and social network analysis on the collected contents, and calculate the evaluation score for the user based on the trust index, the communication index, and the management index.

The at least one processor may compare the evaluation application form of the user with the collected contents to evaluate the trust index of the user as a higher level as a coincidence degree becomes higher.

The at least one processor may evaluate the communication index of the user as a higher level as activity on the SNS of the user becomes higher.

The at least one processor may evaluate the communication index of the user based on at least one of a number of times of expressing an interest in a post of another person on the SNS account of the user, a number of times of obtaining an interest of other people in a post of the user, a number of posts posted by the user, a number of comments posted by the user, a number of posts of other people shared by the user, and a time spent by the user for using the SNS account, and may provide a weight to the communication index corresponding to a number of times of expressing an interest in a post between the user and a friend having a high connection with the user, a number of times of sharing a post, and a number of times of leaving a comment.

The at least one processor may analyze at least one of a type, frequency, and story of contents posted by the user and friends connected to the user to evaluate the management index of the user as a higher level as consistency of the contents posted by the user and the friends connected to the user becomes higher.

The evaluation score may include at least one of a credit assessment for the user, a personnel assessment for the user, and a marketing strategy for the user.

According to another embodiment of the present invention, there is provided a method for evaluating a user by analyzing a social network, the method including: analyzing SNS activity of a user by using information about an SNS account of the user and information including an evaluation application form of the user; and calculating an evaluation score for the user based on the analyzed SNS activity of the user to provide the calculated evaluation score.

The analyzing of the SNS activity of the user may include collecting at least one of personal information, created contents, shared contents, friend relationship, and activity contents from the SNS account of the user, and evaluating a trust index, a communication index, and a management index of the user by performing text mining, opinion mining, and social network analysis on the collected contents, and the calculating of the evaluation score for the user to provide the calculated evaluation score may include calculating the evaluation score for the user based on the trust index, the communication index, and the management index.

According to still another embodiment of the present invention, there is provided a system for evaluating a user, the system including: a user terminal; an analysis request server for transmitting SNS account information and an evaluation application form of the user, which are received from the user terminal, to an evaluation analysis server, and providing an evaluation score for the user, which is received from the evaluation analysis server, to the user terminal; an SNS analysis server for transmitting the SNS account information and the evaluation application form of the user, which are received from the analysis request server, and an SNS activity information request for the SNS account of the user to an SNS server, and analyzing SNS activity information received from the SNS server to calculate the evaluation score and provide the calculated evaluation score to the evaluation application server; and the SNS server for transmitting the SNS activity information, which includes a history of activity performed with the SNS account, to the evaluation analysis server when the SNS server receives the SNS account information and the evaluation application form of the user, which are received from the evaluation analysis server, and the SNS activity information request for the SNS account of the user.

### Advantageous Effects

According to the present invention, persons who wish a loan without financial transactions can get an additional opportunity to receive a loan, and a person who wishes a loan with high financial performance but has a high default rate can be discriminated.

In addition, upon employee recruitment, aptitude that may not be easily recognized with only a resume and an interview can be evaluated.

In addition, propensities and needs of customers can be evaluated more accurately and quickly, and it can be determined whether the customer is a black consumer.

### DESCRIPTION OF DRAWINGS

FIG. 1 shows a system for evaluating a user according to an embodiment of the present invention.

FIG. 2 shows an example in which a service for evaluating a user is provided according to an embodiment of the present invention.

FIG. 3 is a block diagram showing a configuration of an SNS analysis server and a user terminal according to an embodiment of the present invention.

FIG. 4 shows a process of providing a user evaluation service in the user terminal according to an embodiment of the present invention.

FIG. 5 is a flow chart showing the user evaluation service according to an embodiment of the present invention.

FIG. 6 is a flow chart showing the user evaluation service in detail, as compared with the flow chart of FIG. 5, according to an embodiment of the present invention.

FIG. 7 shows a process of analyzing activity information in a processor according to an embodiment of the present invention.

FIG. 8 shows a process of analyzing activity information in a processor according to an embodiment of the present invention.

FIG. 9 shows an example of a report created by analyzing SNS activity information according to an embodiment of the present invention.

### BEST MODE

### Mode for Invention

Hereinafter, exemplary embodiments of the present invention will be described in detail with reference to the accompanying drawings.

Advantages and features of the present invention and methods of accomplishing the same will be understood more readily with reference to the following detailed description of embodiments taken in conjunction with the accompanying drawings. However, the present invention may be embodied in various other forms, and should not be construed as being limited to the embodiments set forth herein. The embodiments are provided so that the disclosure of the present invention will be thorough and complete, and will fully convey the scope of the invention to those of ordinary skill in the art to which the present invention pertains. The present invention will only be defined by the scope of the appended claims. Like reference numerals refer to like elements throughout the specification.

Unless defined otherwise, all terms (including technical terms and scientific terms) used herein have the same meaning as how they are generally understood by those skilled in the art to which the present invention pertains. In addition, unless expressly and explicitly defined otherwise, any term that is defined in a general dictionary shall not be interpreted to have an idealistic or excessive meaning. The terms used herein are intended to describe certain embodiments only, and shall by no means limit the present invention. In the present specification, unless the context explicitly dictates otherwise, expressions in a singular form include a meaning of a plural form.

In addition, the terms such as “comprise” and/or “comprise” used herein are intended to specify shapes, numbers, steps, members, elements, or groups thereof that are mentioned, and shall not be construed to preclude any presence or addition of other shapes, numbers, operations, members, elements, or groups thereof that are not mentioned.

Furthermore, a structure or a shape adjacent to anther shape may have a portion overlapping the adjacent shape or arranged below the adjacent shape.

In the present specification, the relative terms such as “below,” “above,” “upper,” “lower,” “horizontal,” or “vertical” may be used to describe a relationship between an element, a layer, or a region and another element, another layer, or another region as shown in the drawings. These terms encompass not only the orientations shown in the drawings but also other directions of the device.

In the following, the present invention will be described with reference to sectional views that schematically show exemplary embodiments (and intermediate structures) of the present invention. In these drawings, for example, the size and shape of the members may be exaggerated for convenience and clarity of explanation. In actual implementation, modifications of the shape shown in the drawings may be expected. Thus, embodiments of the present invention are not limited to any particular shape of regions shown in the present disclosure.

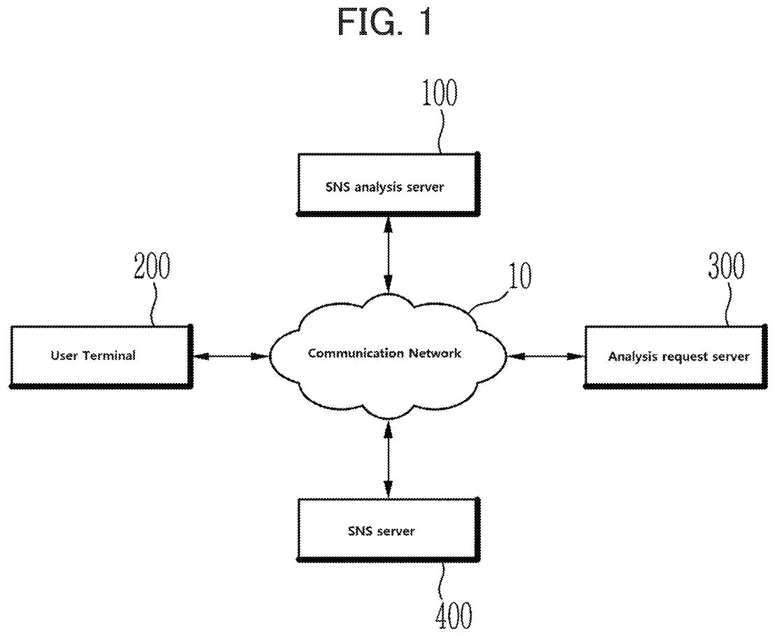

FIG. 1 shows a system for evaluating a user according to an embodiment of the present invention.

First, a process of applying a system for evaluating a user according to the present invention will be briefly described. The user, who is an evaluation target, may be a loan applicant, a job applicant, or a marketing target customer. An analysis requester includes a financial institution such as a bank, a company under a job offer, a promoter who provides a predetermined gift upon joining or purchase of a product, or a company that intends to conduct customized marketing. The analysis requester transmits information about the user to an analyst. The information about the user may include information about a social networking service (hereinafter referred to as “SNS”) account of the user, an application form of the user, etc. The analysis requester may transmit the purpose of analysis, which is at least one of a credit assessment, a personnel aptitude assessment, a black consumer assessment, and a marketing purpose, to the analyst. In addition, the analysis requester may transmit at least one of requests to the analyst to request the analyst to analyze only the SNS account of the user, to request the analyst to further provide an evaluation score or an evaluation rating based on the analysis of the SNS account, or to request the analyst to further provide an analysis report. Finally, the analysis requester may transmit information about required propensities to the analyst. The analyzer creates a desired result according to the request of the analysis requester to transmit the created result to the analysis requester.

The system for evaluating the user according to an embodiment of the present invention includes an SNS analysis server 100, a user terminal 200, an analysis request server 300, and an SNS server 400. The SNS analysis server 100 is operated by the analyst, the user terminal 200 is operated by the user or the marketing target customer, and the analysis request server 300 is operated by the analysis requester 300. The SNS server 400 is operated by an SNS service provider that provides an SNS service to the user.

The SNS analysis server 100, the user terminal 200, the analysis request server 300, and the SNS server 400 may establish a system for performing data communication with each other through a communication network 10, and may communicate with each other through various generally-known schemes of wired/wireless communication standards such as Wifi, LTE, 3GPP, LAN, and Ethernet. The communication network 10 includes a mobile communication network and the Internet, as well as all of the worldwide open network architectures that provide the TCP/IP protocol and various services existing in an upper layer thereof, that is, hyper text transfer protocol (HTTP), Telnet, file transfer protocol (FTP), domain name system (DNS), simple mail transfer protocol (SMTP), simple network management protocol (SNMP), network file service (NFS), etc.

The mobile communication network may include elements such as an access gateway and a packet data serving node (PDSN) that enable transmission and reception of wireless packet data in addition to a base station (BS), a mobile telephone switching office (MTSO), and a home location register (HLR).

The SNS analysis server 100, the user terminal 200, the analysis request server 300, and the SNS server 400 are configured to transmit and receive information as requests or specific events occur between each other. The SNS analysis server 100, the user terminal 200, the analysis request server 300, and the SNS server 400 may store the transmitted and received information, may transmit requested information among the stored information, or may analyze the received information to provide an analysis result. The transmitted and received information includes various data such as images, texts, and applications regardless of the type of data.

The SNS analysis server 100 requests SNS activity information of the user to the SNS server 400 when the SNS analysis is requested from the analysis request server 300. The SNS analysis server 100 analyzes the SNS activity information received from the SNS server 400 to transmit an analyzed result to the analysis request server 300. The SNS analysis server 100 may analyze an SNS of the user to evaluate credit, aptitude, black consumer tendency, or marketing orientation of the user. The SNS analysis server 100 may be operated by an alternative evaluation service provider, which is the analyst. The SNS analysis server 100 calculates various evaluation indexes such as a trust index, a communication index, and a management index based on the SNS activity information of the user, and determines the evaluation score of the user based on the calculated evaluation index. The SNS analysis server 100 may determine the rating of the user based on the determined evaluation score. The SNS analysis server 100 may analyze the marketing orientation for the user by analyzing the evaluation index with a user propensity, a consumption pattern, preference, etc. When the analysis is completed, the SNS analysis server 100 transmits the determined evaluation score or the determined evaluation rating of the user to the analysis request server 300. Depending on embodiments, the SNS analysis server 100 may create the analysis report based on the analysis of the SNS activity information of the user, and may transmit the created analysis report to the analysis request server 300.

The user terminal 200 is an electronic device, for example, a smart phone, but is not limited thereto. The user terminal 200 may be implemented as any one of a personal computer (PC), a personal digital assistant (PDA), a laptop, a TV, an electronic picture frame, a smart watch, and a wearable device. The user terminal 200 according to the present invention is not limited to the described examples, but is configured to provide information to a user, and may be applied to various kinds of electronic apparatuses which may communicate with other devices.

The user may operate the user terminal 200 to communicate with the SNS server 400, perform the SNS activity, apply for a loan to the financial institution, or apply for employment to the company under the job offer. A loan application form or a job application form is transmitted to the analysis request server 300 together with information about the SNS account of the user according to the operation of the user.

The analysis request server 300 refers to a server operated by the financial institution such as a bank, the company under the job offer, the promoter who provides a predetermined gift upon joining or purchase of a product, or a person who plans to conduct customized marketing, that is, the analysis requester to allow the user to receive the loan or apply for the employment. When the analysis request server 300 receives a document required for the loan or job application from the user terminal 200, information including the document is transmitted to the SNS analysis server 100 to request the SNS analysis of the user. When the evaluation score, the evaluation rating, or the analysis report is received in response to an SNS analysis request, the analysis request server 300 transmits a response to the user terminal 200 based on the received contents. The response transmitted from the analysis request server 300 to the user terminal 200 may include various contents such as loan approval, loan refusal, and pass in an application review process.

The SNS analysis server 100 may provide only an SNS analysis result of the user according to the request of the analysis request server 300, or may complete the evaluation of the user to transmit the completed result to the analysis request server 300. When the SNS analysis server 100 provides only the SNS analysis result of the user, the analysis request server 300 may evaluate the user based on the SNS analysis result and transmit an evaluation result to the user terminal 200. When the SNS analysis server 100 has completed the evaluation of the user, the analysis request server 300 may only serve to transmit the evaluation result received from the SNS analysis server 100 to the user terminal 200. As an additional embodiment, the SNS analysis server 100 may create a report that includes the contents about the evaluation of the user, and may transmit the created report to the analysis request server 300.

The result provided by the SNS analysis server 100 may vary depending on an evaluation purpose. If the evaluation purpose is the credit assessment for the loan, a credit assessment result of the user is provided. If the evaluation purpose is the personnel aptitude assessment of the job applicant, an evaluation result on job availability that represents how high suitability of the job applicant is with respect to the company is provided. If the evaluation purpose is to identify a black consumer or a cherry picker who targets only a company gift, a result on whether the user is an abnormal customer is provided. Finally, if the evaluation purpose is marketing analysis, a result such as a promotion recommendation day of a recommendation product for the user is provided.

The SNS server 400 refers to a server operated by an SNS service provider that provides an SNS service to users. When contents such as images, moving pictures, and texts are received from the user terminal 200, the SNS server 400 stores the contents in a database, and transmits the stored contents to other user terminals. Although one SNS server 400 is shown in the drawing for convenience of explanation, there may be a plurality of SNS servers 400 constructed in mutually different SNS service providers in practice.

The SNS server 400 services to establish a relationship between users and to perform an information exchange between the users with the established relationship. A scheme and terminology of the service that is specifically provided may be implemented differently for each service provider.

In the present embodiment, the SNS server 400 is configured to store activity information on the SNS of the user, and to provide the stored SNS activity information of the user according to the request of the SNS analysis server 100.

For convenience of illustration, one user terminal 200, one SNS analysis server 100, one analysis request server 300, and one SNS server 400 are shown in the drawing, but the present invention is not limited thereto. Since the present invention is applied to a plurality of users, a plurality of analysis requesters, and a plurality of SNS service providers, the system for evaluating the user according to the present invention may include a plurality of user terminals 200, a plurality of SNS analysis servers 100, a plurality of analysis request servers 300, and a plurality of SNS servers 400.

Hereinafter, an example for implementing a system for evaluating a user by analyzing a social network will be described with reference to the drawings.

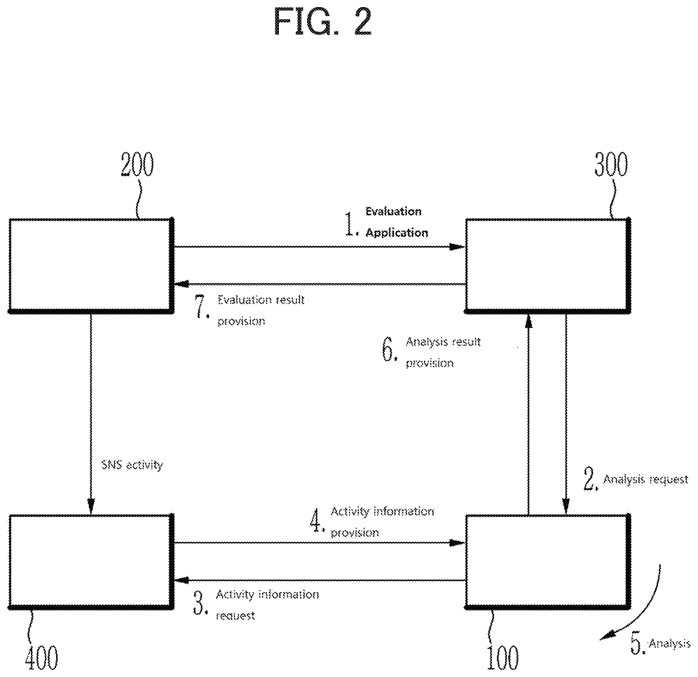

FIG. 2 shows an example in which a service for evaluating a user is provided according to an embodiment of the present invention.

A service for evaluating a user according to an embodiment of the present invention is performed among the SNS analysis server 100, the user terminal 200, the analysis request server 300, and the SNS server 400. In the following, contents of the service for evaluating the user will be introduced for each step.

### SNS Activity of User

The user operates the user terminal 200 to communicate with the SNS server 400, and performs the SNS activity. The SNS activity refers to various activities provided by the SNS server 400 such as posting of contents, sharing of contents of other users, commenting, expressing of an interest with expressions such as likes or retweets to the contents posted by other users, and personal profile configuration, but the present invention is not limited to the described example. The SNS activity of the user is transmitted to other users through the SNS server 400, and the SNS server 400 stores the SNS activity of the user.

### 1. Evaluation Application

The user may operate the user terminal 200 to apply for a loan or to apply for employment. The user may operate the user terminal 200 to join membership or purchase a product to a company where promotion is in progress. In this case, the user creates an application form to transmit the created application form to the analysis request server 300 through the user terminal 200. The application form created at this time is also referred to as ‘evaluation application form’ in the present disclosure for convenience, and a loan application and a job application received from the user terminal 200 are also referred to as ‘evaluation application’ hereinafter for convenience.

The analysis request server 300 may request additional information to the user terminal 200 if the evaluation application of the user exists. The additional information includes information about the SNS account of the user and consent to use of personal information. The information about the SNS account includes an SNS service which is mainly used, an SNS account of the service, and a password for accessing the SNS account. The user terminal 200 transmits the information about the SNS account and a consent form to the analysis request server 300 according to the consent of the user. As another example, the analysis request server 300 may receive the information about the SNS account and the consent form together upon the above loan application or job application.

### 1. Analysis Request

When the analysis request server 300 receives an evaluation request from the user terminal 200, the analysis request server 300 requests the SNS analysis server 100 to analyze the SNS activity of the user. In case of a marketing analysis purpose, the analysis request server 300 may request the SNS analysis server 100 to analyze the SNS activity even when no evaluation request is provided from the user terminal 200. In this case, since no separate evaluation application is provided from the user, the analysis request server 300 may not transmit the evaluation application form to the SNS analysis server 100. The analysis request server 300 may request a weight according to a requested human character. For example, the analysis request server 300 may transmit various contents such as a political orientation of the user, a time for posting a post, a degree of posting a post, and a type of a post usually posted about the company together with an analysis request. The analysis request server 300 transmits an evaluation purpose, which is a credit assessment, a personnel aptitude evaluation, a black consumer assessment, or marketing, to the SNS analysis server 100 together with the analysis request. Further, the analysis request server 300 may determine whether only an analysis result is requested, whether the evaluation result is further requested, or whether the analysis report is further requested to transmit the determined result to the SNS analysis server 100.

For the analysis request, the analysis request server 300 provides the information about the SNS account of the user and the consent form to the SNS analysis server 100. The analysis request server 300 may simultaneously perform requests for a plurality of users.

As described above, the analysis request server 300 may request only the analysis of the SNS activity of the user, or may request the evaluation for the user after the analysis.

### 2. Activity Information Request

When the analysis of the SNS activity of the user is requested from the analysis request server 300, the SNS analysis server 100 requests the activity information on the SNS of the user to the SNS server 400. In order to request the activity information, the SNS analysis server 100 may provide the SNS account and the password for accessing the account of the user together with a personal information use consent form.

### 3. Activity Information Provision

The SNS server 400 provides the SNS activity information of the user to the SNS analysis server 100 in response to the request of the SNS analysis server 100. The SNS activity information includes various information such as profile information of the user, posted contents, information on other related users, shared contents, contents to which an interest is expressed, and posted comments. Furthermore, the SNS server 400 may provide public activity information of users related to the user who is the evaluation target to the SNS analysis server 100 in response to the request of the SNS analysis server 100.

### 4. Analysis

The SNS analysis server 100 analyzes the SNS activity information of the may analyze differently according to the analysis purpose received from the analysis request server 300. Further, the SNS analysis server 100 may perform the analysis by providing weights differently according to the propensities of the user received from the analysis request server 300. The SNS analysis server 100 analyzes the SNS activity information to perform matching with the evaluation application form, and creates a relationship network node by schematizing the relationship with another user. Then, the SNS analysis server 100 analyzes the matching and the relationship network node to evaluate various indexes such as the trust index, the communication index, and the management index of the user, and analyzes a related term related to the user. The trust index is calculated based on a degree of correspondence between the evaluation application form and the SNS activity information of the user. The communication index is calculated based on a level of the SNS activity performed by the user. The management index is calculated based on a degree of consistent management performed by the user on the SNS account. Each of the indexes may be scored from 0 to 1000. The analysis may be performed with different weights applied due to a special request of the analysis request server 300. For example, when the SNS analysis server 100 is requested from the analysis request server 300 to calculate the score as a lower level when the user frequently uses a post including a specific keyword, or to reflect, when being requested to unconditionally rate as failing in the case where the trust index is less than a predetermined score, the rating request. When the user did not use the SNS for a predetermined level or more, the SNS analysis server 100 may make an evaluation impossible determination and notify the determination. As an additional example, if basic personal information such as a name and sex does not correspond to the evaluation application form, the SNS analysis server 100 may also make the evaluation impossible determination and notify the determination.

The SNS analysis server 100 determines the score of the user as an average of calculated index scores. The SNS analysis server 100 may change the score to a rating to determine the rating of the user. For example, the SNS analysis server may determine class A for an average score of 1000 to 900, class B for an average score of 900 to 800, class C for an average score of 800 to 700, and class F for an average score of 700 or less. This may be determined differently in response to the request received from the analysis request server 300.

The SNS analysis server 100 evaluates the user based on the analysis result and creates a report. The report including the analysis result may include at least one of a schematized score for each of the indexes of the user, data such as a paper on which the calculation of the score is based, advice for increasing the score, and comments on the propensities of the user.

### 5. Analysis Result Provision

The SNS analysis server 100 transmits a completed result to the analysis request server 300. If the analysis purpose is the credit assessment or the personnel aptitude assessment, information on the analysis result of the SNS of the user and suitability is provided. If the analysis purpose is the marketing analysis, the analysis result of the SNS of the user, a sales recommendation product, and a promotion recommendation time zone may be provided together.

### 6. Evaluation Result Provision

The analysis request server 300 completes the evaluation of the user based on the report, and transmits the result to the user terminal 200. For example, the evaluation result may be about a loan approval state when the evaluation application is the loan application, may be about a pass state of the application review process when the evaluation application is the job application, or may be about a product purchase state or a joining approval state when the evaluation application is the purchase of the product or the joining to a site for a gift. If the user is rejected, the user may try new application by supplementing the SNS activity. To this end, the result may include information on a supplementary point.

In the case where the evaluation is completed and the evaluation result is transmitted from the SNS analysis server 100, the analysis request server 300 retransmits the received evaluation result or the received analysis report to the user terminal 200.

If the analysis purpose was the marketing analysis, the analysis request server 300 does not provide a separate result to the user terminal but stores the result in the database, and uses the stored information in future.

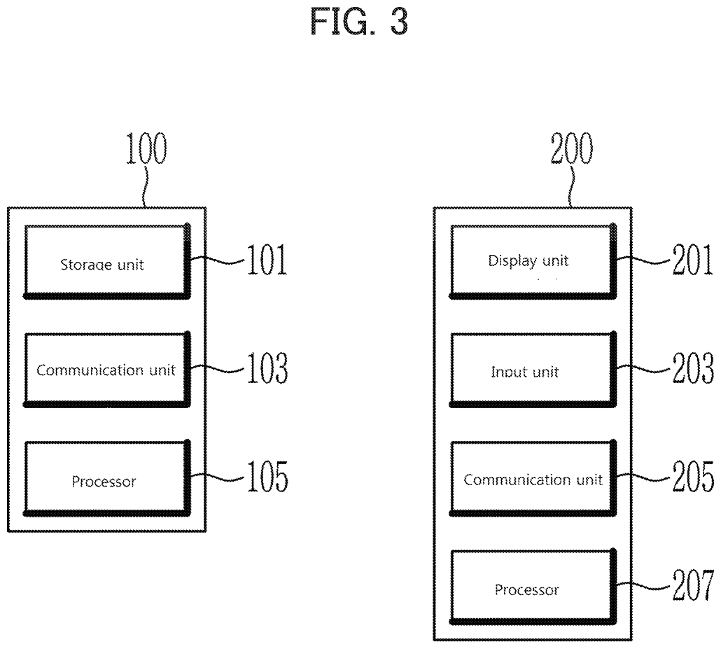

The user terminal 200 provides the result received from the analysis request server 300 to the user. FIG. 3 is a block diagram showing a configuration of an SNS analysis server and a user terminal according to an embodiment of the present invention.

The SNS analysis server 100 and the user terminal 200 may be implemented in various schemes such as a server-based computing structure, a grid computing structure, and a cloud computing structure, and elements of the SNS analysis server 100 and the user terminal 200 are divided into functional units as shown in FIG. 3 regardless of such a structure. Therefore, the elements of the SNS analysis server 100 and the user terminal 200 shown below may be integrated in one device, or distributed in a plurality of devices in actual implementation. In the following, configurations of the analysis request server 300 and the SNS server 400 are similar to the configuration of the SNS analysis server 100, so the detailed description thereof will be omitted.

The SNS analysis server 100 according to an embodiment of the present invention includes a storage unit 101, a communication unit 103, and a processor 105. The SNS analysis server 100 may further include various configurations for operation, but the description thereof will be omitted.

The storage unit 101 is a configuration for storing information and data. The SNS analysis server 100 may include the storage unit 101 for storing various information and data. The storage unit 101 may be provided as a writable nonvolatile memory (writable ROM) that may store data even if a power supplied to the SNS analysis server 100 is shut off and may reflect changes. In other words, the storage unit 101 may be provided as any one of a flash memory, an EPROM, and an EEPROM.

In addition, the storage unit 101 may include a volatile memory in which recorded data is lost when the power of the SNS analysis server 100 is shut off. In other words, the storage unit 101 may include any one of a DRAM and an SRAM that may allow reading and writing of information and may have a read or write speed much faster than a read or write speed of a nonvolatile memory.

The communication unit 103 is a configuration for allowing the SNS analysis server 100 to communicate externally. The communication unit 103 allows the SNS analysis server 100 to communicate with the user terminal 200, the analysis request server 300, the SNS analysis server 100, and the like under control of a control unit, and transmits and receives data. The SNS analysis server 100 may include a connection unit for wired communication to communicate with an external device. The connection unit may transmit/receive signals/data according to specifications of a high definition multimedia interface (HDMI), high definition multimedia interface-consumer electronics control (HDMI-CEC), USB, a component, and the like, and includes at least one connector or terminal corresponding to each of the specifications. The SNS analysis server 100 may perform the wired communication with a plurality of servers through a wired local area network (LAN). In addition, the SNS analysis server 100 may include an RF circuit for transmitting and receiving a radio frequency (RF) signal to perform wireless communication, and may be configured to perform at least one of communication such as Wi-fi, Bluetooth, Zigbee, ultra-wide band (UWM), wireless USB, and near field communication (NFC).

The SNS analysis server 100 may include a control unit for controlling an overall operation of the SNS analysis server 100. A control module may include a control program, a nonvolatile memory in which the control program is installed, a volatile memory in which at least a part of the control program is loaded, and at least one processor 105 or a central processing unit (CPU) for executing the loaded control program. The control program may include a program(s) implemented in the form of at least one of BIOS, a device driver, an operating system, firmware, platform, and an application program (application). As one embodiment, the application program may be pre-installed or stored in the SNS analysis server 100 upon manufacturing of the SNS analysis server 100, or data of the application program may be received from an outside so that the application program may be installed in the SNS analysis server 100 based on the received data upon use in future. The data of the application program may be, for example, downloaded from an application market.

The user terminal 200 according to an embodiment of the present invention includes a display unit 201, an input unit 203, a communication unit 103, and a processor 105. The user terminal 200 may further include various other configurations for operation, but the description thereof will be omitted.

The display unit 201 displays the contents on the user terminal 200. As an example, the display unit 201 may be configured to display received information, a UI, etc. The display unit 201 displays an image based on an image signal processed by a signal processing unit of the user terminal 200. The display unit 201 may include a touch sensing unit for sensing a touch input of the user, and a display panel for displaying the image. Implementation schemes of the display panel are not limited, and the display panel may be, for example, implemented in various display schemes such as a liquid crystal, plasma, a light-emitting diode, an organic light-emitting diode, a surface-conduction electron-emitter, a carbon nano-tube, and a nano-crystal.

When the display panel is implemented in a liquid crystal scheme, the display unit 201 includes the liquid crystal display panel, a backlight unit for supplying light to the liquid crystal display panel, and a panel driving substrate for driving the liquid crystal display panel. The display unit 201 may be implemented as an OLED display panel which is a self-luminous element without the backlight unit.

The input unit 203 receives a command of the user. As an example, when the user operates the input unit 203 of the user terminal 200 to input a command, the command is received, and a signal is transmitted to the control unit. The input unit 203 may be implemented in various forms according to a user input scheme. The input unit 203 may be variously implemented such as a scheme of including the input unit 203 in a menu button provided on an outside of the user terminal 200, a remote control signal reception unit for receiving a remote control signal of a user input received from a remote controller, a touch input reception unit for receiving a touch input of a user, a camera for detecting a gesture input, a microphone for recognizing a voice input, and the communication unit 103 for communicating with an external device to receive a user input from the external device.

The touch sensing unit senses a touch from a touch means such as a touch pen or a finger to the display panel. The touch sensing unit may be provided on a front surface of a display where an image is displayed. A structure of the touch sensing unit includes a transparent electrode and a capacitance sensing circuit arranged in a matrix on the display panel. The touch sensing unit may have a so-called GFF or G2 structure using a transparent electrode such as ITO, metal ash, or an Ag nano wire, or may be implemented in the form of flexible printed circuit board (FPCB) or the like, which has a structure in which a conductive material is oriented by using a material such as an opaque flexible film as a substrate, but the present invention is not limited to such a capacitive scheme.

The communication unit 205 is configured to perform communication with a server. The communication unit 205 operates with a configuration similar to the communication unit 205 of the server, so the detailed description thereof will be omitted.

The user terminal 200 may include a control unit, and the control unit may include a nonvolatile memory in which a control program is installed, a volatile memory in which at least a part of the control program is loaded, and at least one processor 207 for executing the loaded control program. A configuration of the control unit is similar to the configuration of the control unit of the server, so the detailed description thereof will be omitted.

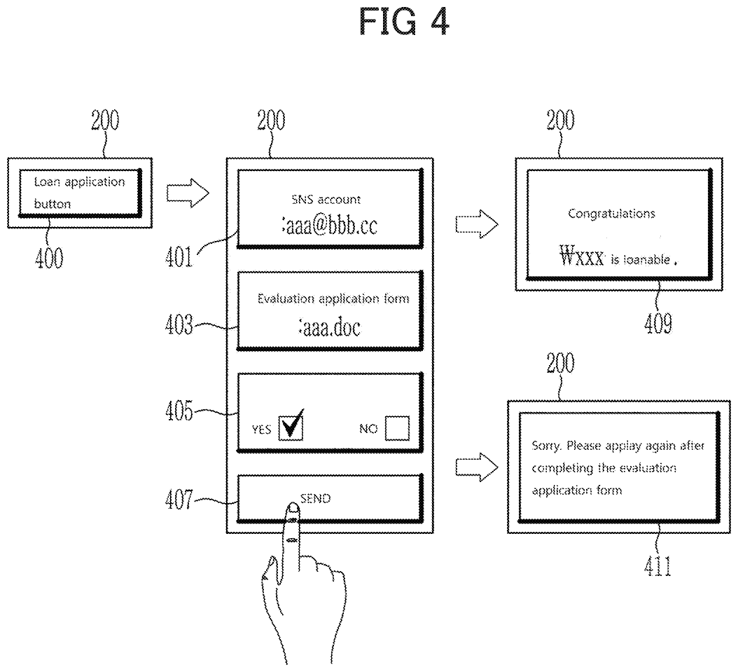

FIG. 4 shows a process of providing a user evaluation service in the user terminal according to an embodiment of the present invention.

As described above, the evaluation of the user according to the present invention may be applied to various fields such as the credit assessment for the loan, the personnel aptitude assessment of the job applicant, or the marketing analysis. In the following, the system for evaluating the user according to the present invention will be described through a process of applying for a loan, which is one of the various fields to which the present invention is applied.

The analysis request server 300 provides UI items 400, 401, 403, 405, 407, 409, and 411 for facilitating the loan application according to a request of the user. The user operates the user terminal 200 to select a loan application item 400. When the user selects the loan application item 400, the user terminal 200 requests the loan to the analysis request server 300. As next steps, the user uses the UI items 401, 403, and 405 provided through the user terminal 200 to fill in information about the SNS account, attaches the evaluation application form, and indicates the consent to share the personal information. Finally, when the user selects a send item 407, the information is transmitted to the analysis request server 300.

As described above, the analysis request server 300 transmits the information about the SNS account and the evaluation application form, which are received from the user, to the SNS analysis server 100, and responds to the request of the user based on the analysis result received from the SNS analysis server 100.

The response of the analysis request server 300 may be a loan approval 409 or a loan refusal 411. The analysis request server 300 may transmit the created report received from the SNS analysis server 100 to the user terminal 200, and the user may review the report to supplement a lacking portion thereof.

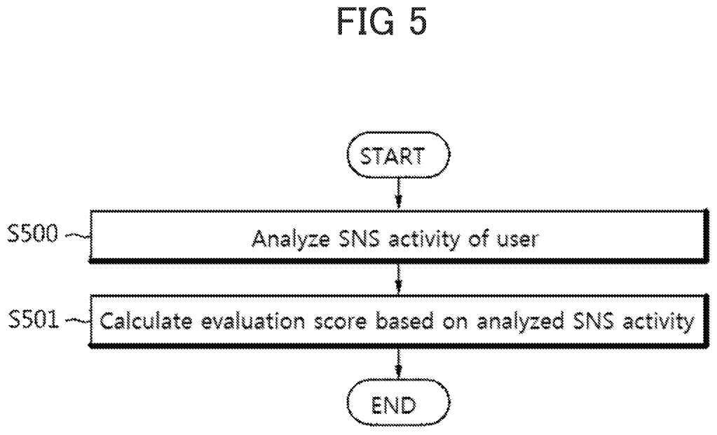

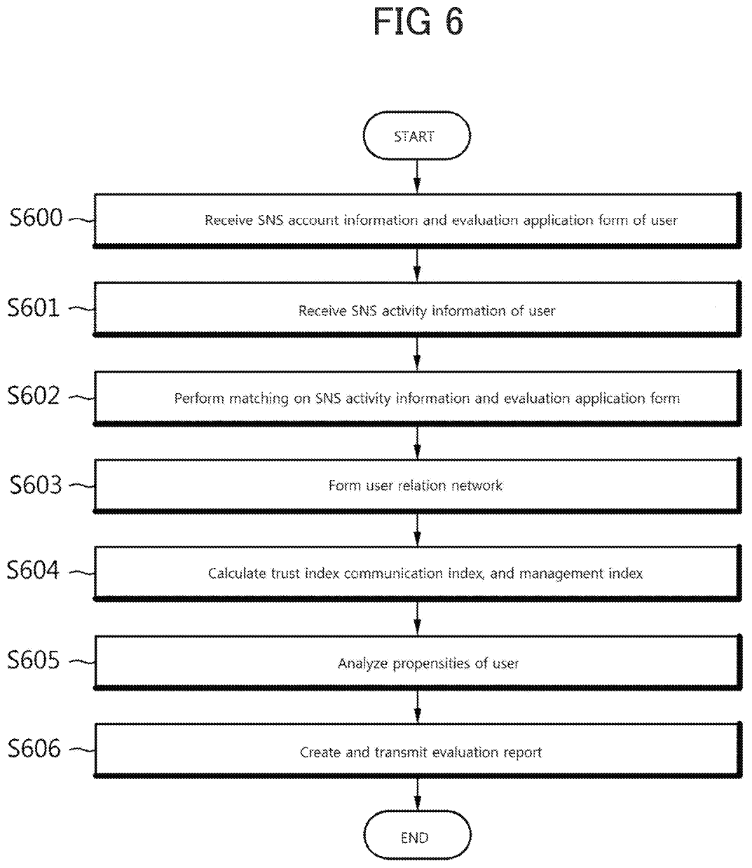

FIG. 5 is a flow chart showing the user evaluation service according to an embodiment of the present invention, and FIG. 6 is a flow chart showing the user evaluation service in detail, as compared with the flow chart of FIG. 5, according to an embodiment of the present invention.

Referring to FIG. 5, in operation S500, the SNS analysis server 100 analyzes the SNS activity of the user. In addition, in operation S501, the SNS analysis server 100 calculates an evaluation score for the user based on the analyzed SNS activity of the user to provide the calculated evaluation score. The provided evaluation score may be provided in the form of a report.

FIG. 6 describes in more detail a process evaluating the user when the evaluation purpose is the credit assessment or the personnel aptitude evaluation. In the following, referring to FIG. 6, first, in operation S600, the SNS analysis server 100 receives the SNS account information and the evaluation application form of the user from the analysis request server 300. The SNS account information includes an ID, a password, and the like for accessing the SNS of the user. The evaluation application form is a document prepared by the user for the loan or the employment, and may include the personal information of the user and the like.

In operation S601, the SNS analysis server 100 requests the SNS activity information of the user to the SNS server 400, and receives the SNS activity information of the user from the SNS server 400 in response to the request. The SNS activity information is a history of the SNS activity performed by the user operating the user terminal 200 to communicate with the SNS server 400, and includes various information such as personal profiles saved in the SNS, posted posts, posted comments, information of other users connected through the SNS, the number of times of expressing an interest, shared posts, posts shared by friends, posts, comments, and the number of connected users.

Subsequently, in operation S602, the SNS analysis server 100 performs matching to recognize whether the SNS activity information of the user corresponds to contents of the evaluation application form, and in operation S603, a relationship network is formed with other users by using the SNS activity information of the user. A matching result and the formed relationship network are used to calculate an index of the user in future.

Thereafter, in operation S604, the SNS activity information of the user, the matching result, and the relationship network of the user are analyzed to calculate the trust index, the communication index, and the management index of the user.

In operation S605, the SNS analysis server 100 analyzes the SNS activity information of the user to analyze a detailed emotion and a related word of the user. This means that a lifestyle and the like of the user is analyzed by recognizing an emotional classification and the related word among words used during the SNS activity of the user through map reducing.

Finally, in operation S606, the SNS analysis server 100 creates an evaluation report for the user and transmits the created evaluation report to the analysis request server 300.

If the analysis purpose is the marketing analysis, the evaluation application form or the evaluation request is not received from the user terminal to the analysis request server 300. The analysis request server 300 requests the SNS analysis server 100 to perform the marketing analysis on at least one user. The analysis request server 300 may transmit a name, a telephone number, an e-mail address, a date of birth, a home address, and the like of the user, who is a target of the marketing analysis, to the SNS analysis server 100. The SNS analysis server 100 identifies the SNS account and the like of the user by using the information of the user. The SNS analysis server 100 requests the activity information based on the identified SNS account of the user to the SNS server 400. At this time, only the public information among the requested activity information may be requested. The SNS analysis server 100 analyzes the activity information received from the SNS server 400 to understand the propensities and needs of the analyzed user. The SNS analysis server 100 may allow the user to be included in various groups with reference to photographs and articles posted by the user, contents to which an interest is expressed by the user, and other related users. As examples of the groups, the groups may include a female career starter group, a self-ostentation group, a streaming shopper group, a beauty interest group, and the like, but the groups are not limited to the examples described above.

The SNS analysis server 100 recommends a product suitable for the user based on an interest degree of the analyzed user with respect to the product for each group. The SNS analysis server 100 may provide the SNS analysis result of the user, the sales recommendation product, the promotion recommendation day, and the like as a result.

The analysis request server 300 may perform promotion by recommending a recommended product to the user on a recommended day based on the result.

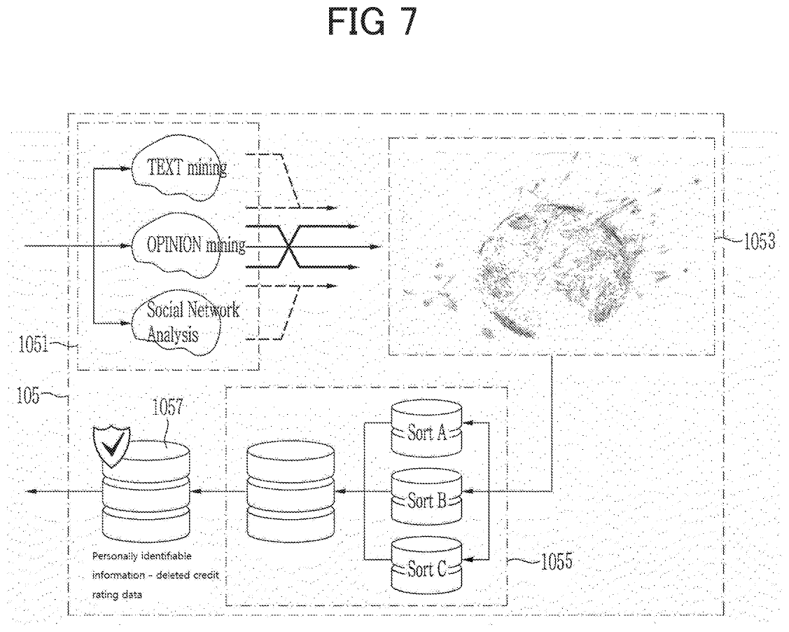

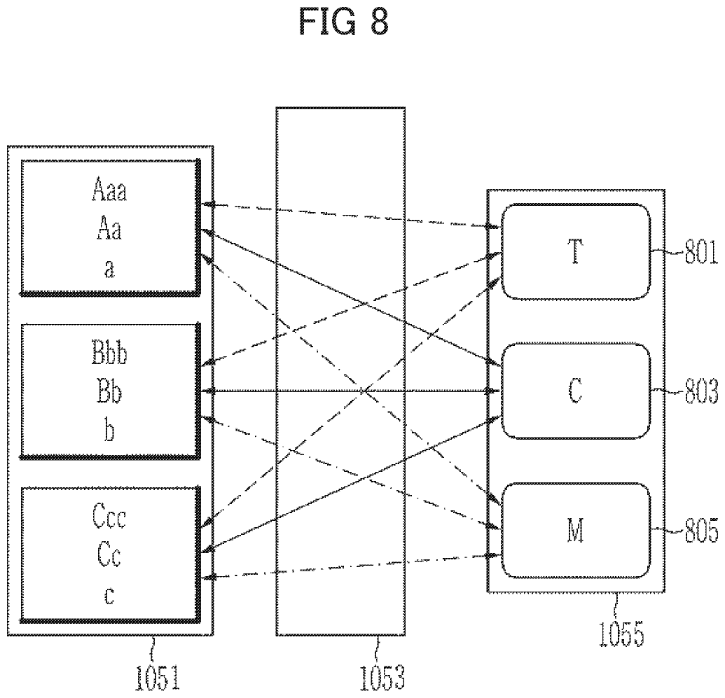

FIGS. 7 and 8 show a process of analyzing activity information in a processor according to an embodiment of the present invention.

The processor 105 includes a plurality of modules 1051, 1053, 1055, and 1057 for analyzing the SNS activity information of the user.

First, a mining module 1051 performs text mining, opinion mining, and relationship network formation on the received SNS activity information. The mining module 1051 may serve to search for the SNS account of the user based on the information about the user when performing analysis with a purpose of marketing.

Based on a mined text, a mined opinion, and the formed relationship network, an analysis module 1053 analyzes an SNS participation degree, a daily life reflection degree, frequency of interaction with acquaintances, relationship persistency with acquaintances, relationship expandability with other people, a degree of political, cultural, and social participation, and the like of the user, and organizes and analyzes data.

An evaluation module 1055 performs evaluation on the user based on the organized and analyzed data. In order to perform the evaluation on the user, first, the evaluation module 1055 may calculate the trust index, the communication index, and the management index of the user, and determine the evaluation score and/or the evaluation rating of the user based on the calculated indexes. When performing the analysis with the purpose of marketing, the evaluation module 1055 may form a group of users based on a consumption pattern of the user, an interest of the user, and the like together with the trust index, the communication index, and the management index of the user, and may extract interests of the formed group to select a product necessary for the user and the promotion recommendation day. Furthermore, the SNS activity analysis may be used to determine whether the user is a so-called black consumer or cherry picker who returns a product after collecting a gift or a part of components of the product, returns the product even when there is a trace of wear, or repeatedly cancels an order. The trust index depends on whether the evaluation application form of the user matches an SNS activity record. The trust index is calculated by analyzing the SNS activity information with respect to a residence, a school register, a job, family relationship, and the like to perform the matching with the evaluation application form. For basic information such as a name and an age, a weight may be provided to the calculation of the trust index if the basic information is inconsistent. The evaluation module 1055 may determine whether the evaluation application form is authentic by using external information in addition to SNS information. For example, the evaluation module 1055 may check whether information on the name, a job, a job title, and a salary of the user matches health insurance information, and may gather Internet banking balances for each bank with the consent of the user to compare the gathered Internet banking balances with the evaluation application form of the user. If the user publicly discloses more information of the SNS and utilizes the SNS more, and there is no inconsistency with the evaluation application form, the user may get a high trust index. If most of the information of the user is not publicly available, the user may not get a high score in the trust index.

The evaluation module 1055 may review the relationship network of the user for more accurate analysis. For example, while the user has stated in the evaluation application form that the user has graduated from Seoul National University, if there are very few people who graduated from Seoul National University in the relationship network, and the user does not communicate with the people, the user may be suspected of an academic background. In addition, while the user has stated in the evaluation application form that the user is a doctor, if the user does not establish a relationship people in related occupations and does not communicate with people in related occupations, the user may not get a high trust index.

If the basic information such as the name is determined to be inconsistent when comparing the evaluation application form with the SNS activity information, the evaluation module 1055 may give the lowest score in the trust index, and the request of the user may be rejected regardless of scores of other indexes when the lowest score is given in the trust index.

The communication index is calculated based a degree of communication performed by the user with other users. To this end, the evaluation module 1055 may calculate the communication index of the user based on at least one of the number of times of expressing an interest in a post of another person on the SNS account of the user, the number of times of obtaining an interest of other people in a post of the user, the number of posts posted by the user, the number of comments posted by the user, the number of posts of other people shared by the user, and a time spent by the user for using the SNS account, and may provide a weight to the communication index corresponding to the number of times of expressing an interest in a post between the user and a friend having a high connection with the user, the number of times of sharing a post, and the number of times of leaving a comment.

The evaluation module 1055 does not simply count the number of likes, shares, comments, and the like, but may also give reliability to communication of closely related friends to give a weight. Furthermore, a large number of related users who share contents may be one of factors that may attain a high communication index.

As an example, the evaluation module 1055 determines the number of times of expressing an interest by the user, the number of comments, the number of shares, an average time of the comment, a period of using the SNS account, the number of recent posts, the number of contents, diversity of a contents type.

The management index is an index representing a degree representing whether the user is self-managing excellently, that is, whether the user has been excellently managing the SNS account. The evaluation module 1055 evaluates the management index based on whether the user consistently posts a similar kind of contents or the like. To this end, the evaluation module 1055 receives the analyzed result from the analysis module 1053. The analysis module 1053 analyzes a type of the mined contents in advance. The analysis module 1053 performs analysis to understand whether the contents are photographs, texts, or videos, whether a detail contained in the contents is a person, an animal, a landscape, of food, whether the person is the user, a family member, or a friend in the case where the detail is about the person, how much hash tags are set in the post, how many letters are put in the post, etc.

The evaluation module 1055 may analyze whether the user is consistently managing the contents and whether other users are excellently managing the contents with reference to the result received from the analysis module 1053. Even if contents consistency of the user is low, the management index of the user may be evaluated as a higher level when the contents of other users having the relationship with the user have strong consistency.

The evaluation result includes evaluation scores requested by the analysis requester, such as the credit rating, personnel employment possibility, aptitude, and ease of marketing. The evaluation module 1055 may create the evaluation report based on the evaluation result if necessary. The evaluation module 1055 may further receive external data in the process of evaluating the user to utilize the received data for creation the report. Machine learning may be applied to the evaluation module 1055, so that a more accurate report may be created as the number of evaluations increases.

A security module 1057 deletes personal identification information such as the credit rating, and performs security encryption such as masking on generated information to transmit the generated information. The information on which the security encryption is performed is stored in the storage unit 101 and transmitted to the analysis request server 300 through the communication unit 103.

Referring to FIG. 8, there is illustrated an example in which information is mined by the mining module 1051, data is analyzed in the analysis module 1053, and a trust index 801, a communication index 803, and a management index 805 are calculated and stored in the evaluation module 1055.

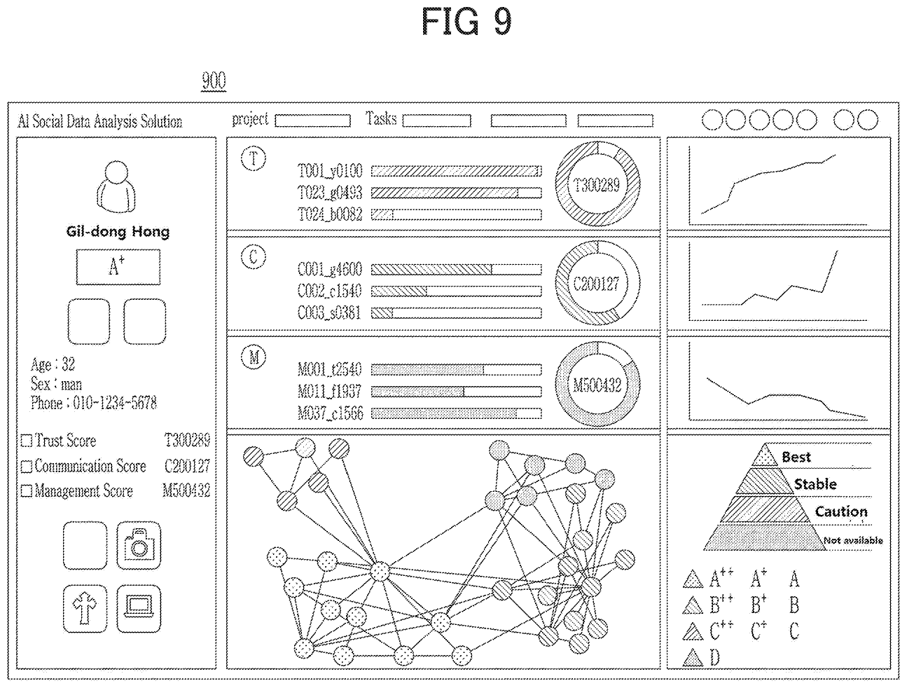

FIG. 9 shows an example of a report created by analyzing SNS activity information according to an embodiment of the present invention.

The SNS analysis server 100 may generate and provide an analysis report 900 in which the SNS of the user is analyzed in addition to the evaluation score or the evaluation rating according to the request of the analysis request server 300. In the generated analysis report 900, information on personal data of the user, the evaluation score for each index of the user, the formed relationship network, the evaluation rating of the user, and the like is disclosed.

In addition, in the analysis report 900, a paper or the like may be presented as a basis for supporting what point of the user is referred to for the evaluation, and information on what point the user lacks may be presented in order to supplement the score.

When the analysis with the purpose of marketing is in progress, the report 900 may include contents about each of the indexes of the user, an SNS usage type of the user, and the like, as well as information on the consumption pattern of the user, the interest of the user, a consumption group of the user, and the like, and the promotion recommendation day of the recommendation product for the user, etc. Furthermore, whether the user is the so-called black consumer or cherry picker who returns a product after collecting a gift or a part of components of the product, returns the product even when there is a trace of wear, or repeatedly cancels the order may be provided to the report through the analysis.

1. A server comprising at least one processor for analyzing SNS activity of a user by using information about an SNS account of the user and information including an evaluation application form of the user, and calculating an evaluation score for the user based on the analyzed SNS activity of the user to provide the calculated evaluation score.

2. The server of claim 1, wherein the at least one processor is configured to collect at least one of personal information, created contents, shared contents, friend relationship, and activity contents from the SNS account of the user, evaluate a trust index, a communication index, and a management index of the user by performing text mining, opinion mining, and social network analysis on the collected contents, and calculate the evaluation score for the user based on the trust index, the communication index, and the management index.

3. The server of claim 2, wherein the at least one processor compares the evaluation application form of the user with the collected contents to evaluate the trust index of the user as a higher level as a coincidence degree becomes higher.

4. The server of claim 2, wherein the at least one processor evaluates the communication index of the user as a higher level as activity on the SNS of the user becomes higher.

5. The server of claim 4, wherein the at least one processor evaluates the communication index of the user based on at least one of a number of times of expressing an interest in a post of another person on the SNS account of the user, a number of times of obtaining an interest of other people in a post of the user, a number of posts posted by the user, a number of comments posted by the user, a number of posts of other people shared by the user, and a time spent by the user for using the SNS account, and provides a weight to the communication index corresponding to a number of times of expressing an interest in a post between the user and a friend having a high connection with the user, a number of times of sharing a post, and a number of times of leaving a comment.

6. The server of claim 2, wherein the at least one processor analyzes at least one of a type, frequency, and story of contents posted by the user and friends connected to the user to evaluate the management index of the user as a higher level as consistency of the contents posted by the user and the friends connected to the user becomes higher.

7. The server of claim 1, wherein the evaluation score includes at least one of a credit assessment for the user, a personnel assessment for the user, and a marketing strategy for the user.

8. A method for evaluating a user by analyzing a social network, the method comprising:
analyzing SNS activity of a user by using information about an SNS account of the user and information including an evaluation application form of the user; and
calculating an evaluation score for the user based on the analyzed SNS activity of the user to provide the calculated evaluation score.

9. The method of claim 1, wherein the analyzing of the SNS activity of the user includes collecting at least one of personal information, created contents, shared contents, friend relationship, and activity contents from the SNS account of the user, and evaluating a trust index, a communication index, and a management index of the user by performing text mining, opinion mining, and social network analysis on the collected contents, and
the calculating of the evaluation score for the user to provide the calculated evaluation score includes calculating the evaluation score for the user based on the trust index, the communication index, and the management index.

10. A system for evaluating a user, the system comprising:
a user terminal;
an analysis request server for transmitting SNS account information and an evaluation application form of the user, which are received from the user terminal, to an evaluation analysis server, and providing an evaluation score for the user, which is received from the evaluation analysis server, to the user terminal;
an SNS analysis server for transmitting the SNS account information and the evaluation application form of the user, which are received from the analysis request server, and an SNS activity information request for the SNS account of the user to an SNS server, and analyzing SNS activity information received from the SNS server to calculate the evaluation score and provide the calculated evaluation score to the evaluation application server; and
the SNS server for transmitting the SNS activity information, which includes a history of activity performed with the SNS account, to the evaluation analysis server when the SNS server receives the SNS account information and the evaluation application form of the user, which are received from the evaluation analysis server, and the SNS activity information request for the SNS account of the user.
